(19) United States
(12) Patent Application Publication
(10) Pub. No.: US 2016/0129512 A1
(43) Pub. Date: May 12, 2016

(54) WIRE ELECTRODE FOR THE DISCHARGE CUTTING OF OBJECTS

(71) Applicant: HEINRICH STAMM GMBH, Iserlohn (DE)

(72) Inventor: ANDRE FRANC, GIVRINS (DE)

(21) Appl. No.: 14/897,411

(22) PCT Filed: Jun. 4, 2014
(86) PCT No.: PCT/DE2014/000298

§ 371 Date: Dec. 10, 2015

(30) Foreign Application Priority Data
Jun. 11, 2013 (DE) 10 2013 009 767.3

(51) Int. Cl. B23H 7/08

(52) U.S. Cl. CPC B23H 7/08

(57) ABSTRACT

A wire electrode for spark erosion is proposed, having a total diameter between 0.05 and 0.4 mm, an inner steel core made of steel and an outer coating surrounding the steel core, which electrode is cost-effective and simultaneously satisfies the mechanical and electrical demands placed thereon, it is further proposed that the coating has an iron-zinc alloy layer and the thickness of the iron-zinc alloy layer at its thinnest point is greater than 5% of the total diameter and at its thickest point is less than 25% of the total diameter.

The invention relates to a wire electrode for spark erosion, having a total diameter between 0.05 and 0.4 mm, an inner steel core made of steel and an outer coating surrounding the steel core.

The invention further relates to a method for producing such a wire electrode.

A wire electrode of the type mentioned in the introduction is already known from DE 196 35 775 A1. The wire electrode disclosed therein consists of a steel core which is surrounded by a brass layer. The brass forms what is referred to as an alpha phase. The alpha brass is in turn surrounded by an outer layer which consists of beta brass.

US 2004 089 636 discloses a wire electrode with a steel core, which takes the form of a fine wire and is surrounded by a coating layer of zinc or of a zinc-aluminum alloy.

EP 0 794 026 describes a wire electrode having a steel core and, surrounding this, a coating of copper, nickel or zinc.

FR 2 936 727 describes a wire electrode with a metallic core having an outer coating layer of an iron-zinc alloy. The iron-zinc alloy has been broken up by the subsequent drawing of the wire electrode, such that the coating exhibits cracks.

In the context of the wires described in these property rights, the core consists of carbon steel or an alloyed steel. The proposed steel core is designed to have high tensile strength so as to be able to reliably withstand even high mechanical stresses in the machining zone. In practice, it would be advantageous for the wire to be under the greatest possible tensile stress since a highly stressed wire is less prone to interference when machining a workpiece and has a lower tendency to deviate from its desired position. For that reason, the manufacturers of such wires attempted to maximize the tensile strength of the steel from which the core of the proposed wire electrodes was to be made.

These proposed wires were however affected by the following drawback: Conventional spark erosion machines are equipped with mechanical devices for unwinding, feeding and guiding the wire, which devices are equipped with a set of fragile plastic pulleys and transport belts. Since these devices have been configured for wires made of softer brass, the use of steel wires would lead to premature wear resulting in downtimes and increased maintenance costs.

In practice, the diameter of wire electrodes having a steel core should be able to vary from specification to specification. Thinner wires, of the size of a hair, do indeed possess sufficient inherent flexibility. However, they must be imbued with a high tensile strength in order to avoid breaking when machining a workpiece. Wire electrodes with larger diameters, by contrast, are more resistant to breakage. However, their flexibility and ductility are often inadequate for the requirements of the unwinding, automatic threading, guiding and wire chopping systems.

Furthermore, a steel core has poor electrical conductivity. This can lead to undesirable localized heating, resulting in the possibility of the wire electrode heated in this manner breaking.

Known brass wire electrodes have, on their surface oriented toward the workpiece to be machined, a zinc fraction that is efficient. The instantaneous vaporization and oxidation of the zinc prevents molten metal particles of the workpiece depositing in the machining slot behind the wire electrode. Such deposits would lead to undesirable wire breakages and would markedly reduce the machining performance of the wire electrode. It is therefore more advantageous to use wires whose cover materials oxidize immediately during machining. In this context, the copper contained in the brass is a bad choice in spite of the advantages connected to its electrical conductivity. The iron alloyed with zinc has, because of its oxidizability, been considered a good replacement for copper. However, the wire lectrodes proposed hitherto have coating layers which were characterized by premature wear, which hampered the effect of the alloy of these coating layers.

The invention has the object of providing a wire electrode of the type mentioned in the introduction, which is cost-effective and simultaneously satisfies the mechanical and electrical demands placed thereon.

The invention achieves this object in that the coating has an iron-zinc alloy layer and the thickness of the iron-zinc alloy layer at its thinnest point is greater than 5% of the total diameter and at its thickest point is less than 25% of the total diameter.

The invention provides a wire electrode with a steel core which endows the wire electrode primarily with the mechanical properties required for spark erosion. The wire electrode is provided with the electrical properties also necessary for this, in the form of sufficient electrical conductivity, primarily by means of the coating with its iron-zinc alloy layer which has a thickness, required for this, of between 5% and 25% with respect to the total diameter of the wire electrode. The minimum and maximum thickness for the iron-zinc alloy layer, required in the context of the invention, represents an optimum compromise for the total diameter range of the wire electrode. In this manner, the two above-mentioned properties are provided to a degree which is sufficient for spark erosion. On one hand, the conductivity of the wire electrode according to the invention comes close to that of a brass wire. Also achieved is a breaking strength which is compatible with commonly available spark erosion machines. An iron-zinc alloy layer with a thickness beyond the required range would indeed provide sufficient electrical conductivity for the wire electrode. However, too thick an iron-zinc alloy layer would reduce the breaking strength of the wire electrode, resulting in the wire electrode breaking during spark erosion. On the other hand, too thin an iron-zinc alloy layer would mean that the wire electrode has insufficient conductivity since, because the steel core is a relatively poor conductor, the electric current primarily flows through the iron-zinc alloy layer.

If the thickness of the iron-zinc alloy layer is approximately 5% of the wire diameter, it is necessary to set the machining parameters of the spark erosion machine so as to reduce the risk of wire breakage. However, this change in parameters can impair the machining performance.

The iron-zinc alloy layer of the wire electrode according to the invention moreover ensures that a sufficient volume of iron and of zinc is introduced into the machining zone such that these metals, which are absolutely necessary for machining, are not consumed too quickly during use.

The term “thickness” of a layer is to be understood as the simple thickness of said layer on one side of the wire electrode.

Advantageously, the wire electrode according to the invention forms, in the coating, a current path which is continuously conductive in the longitudinal direction of the wire electrode. To that end, the iron-zinc alloy layer is designed to be continuously electrically conductive and free from interruptions. This electrically continuous design ensures that the iron-zinc alloy layer with the specified dimensions forms, in the coating and in a continuous fashion, the current path having a lower electrical resistance. Within the context of the invention, it is a basic principle, no matter how the electrical continuity of the layer is brought about. It is thus possible, for example within the context of the invention, for the iron-zinc alloy layer to have multiple alloy phases which, in cross-section, form concentric rings around the steel core. The iron-zinc alloy layer can also consist of three phases, of which two predominate.

According to a preferred configuration of the invention, however, the iron-zinc alloy layer forms a tight packing of layer elements, wherein the layer elements are in contact with one another. Contact between the layer elements is necessary since otherwise there is no conductive connection between the layer elements and the current would not be able to flow unhindered through the iron-zinc alloy. In other words, the iron-zinc alloy layer ensures that the current density in the coating does not fall to zero during operation of the wire electrode. The term layer elements is intended to encompass alloy sections of any shape, thus for example films, flakes, plates, grains or clusters or the like. Layer elements may for example be identified with the aid of a microscope, microscope analysis being optionally preceded by a suitable chemical treatment. In other words, the layer elements form a tight texture of films, flakes, plates, grains or clusters which for example consist of different alloy phases. The tight packing is advantageously a gas-tight packing.

Both continuous formation of the iron-zinc alloy layer and a gas-tight assembly of layer elements in contact with one another improve the protection of the steel core against undesirable oxidation processes. Since the iron of the core is a readily-oxidized metal, a badly stored and insufficiently protected wire can degenerate and become unusable. Oxides, which can form on the turns of a wire coil, can have multiple undesirable effects. First, the diameter of the wire increases unevenly and uncontrollably, resulting in disruption to the operation of the unwinding system of the spark erosion machine. Second, the precision of machining is impaired since the wire coils can stick to one another, making it more difficult to unwind the wire electrode from the spool on which the wire electrode is wound. Third, the surface-oxidized wire causes erosion discharges which can damage or even destroy the devices supplying the current to the machining wire.

It is therefore essential to protect the steel core from oxidation; this requires the thickness, defined according to the invention, of the iron-zinc alloy layer. A locally cracked core coating, proposed in the prior art, would by contrast expose the core outwardly so as to permit the above-described formation of rust.

In order to permit the most effective possible use of the wire electrode in a spark erosion machine, the mechanical properties of the wire must be exactly matched to the respective requirements. The same wire electrode cannot be used for all applications. Moreover, it is necessary to select in a targeted manner the properties of the wire electrode depending on the respective requirement. This holds both for the dimensions of the wire electrode and for the metallurgical composition thereof, it being necessary to coordinate these factors with respect to one another. In the case of wire electrodes having a large total diameter, it is for example necessary to reduce the stiffness of the wire electrode. By contrast, in the case of wire electrodes having a small total diameter, the breaking strength should be increased. In this sense, the total diameter can fall into two categories, with wire electrodes in the first category having a total diameter greater than 0.2 mm and the wire electrodes in the second category having a total diameter less than or equal to 0.2 mm.

In a further variant of the invention, the total diameter is also less than 0.20 mm, the iron fraction in the iron-zinc alloy layer being at most 50 wt %. This can hold for all phases of the iron-zinc alloy in the iron-zinc alloy layer. Within the context of the invention, the iron-zinc alloy layer can also have, in addition to iron and zinc, impurities or deliberately introduced additional materials. The fraction of these latter metals must be carefully measured in order to yield the expected effect during machining.

Advantageously, the zinc content in the iron-zinc alloy layer increases in the outward direction that is to say toward that side of the iron-zinc alloy layer oriented away from the steel core.

It is particularly advantageous if the zinc content in the iron-zinc alloy layer is greater than or equal to 60 wt %.

In the case of a total diameter of less than 0.20 mm, it is moreover advantageous for the steel of the steel core to contain between 0.2 and 0.6 wt % carbon.

In the case of a wire electrode having these dimensions, it is further expedient for the steer core to have a breaking strength between 1000 and 3000 N/mm².

If the total diameter is greater than or equal to 0.20 mm, the steel of the steel core advantageously contains at most 0.2 wt % carbon.

Advantageously, the tensile strength of a wire electrode having a total diameter greater than or equal to 0.20 mm is between 300 and 1100 N/mm².

Advantageously, the steel core is designed such that it is plastically deformable in a plastic region when subjected to a tensile force, and has an extension in its plastic region of at least 10%. If the wire is subjected to an increasing tensile force, there is a range of tensile forces in which the wire electrode deforms elastically. In elastic deformation, the length of the wire electrode increases while the total diameter decreases. If the tensile force is then returned to zero, the wire electrode returns to its original form and once again has the original total diameter. If, however, the tensile force exceeds the maximum elastic deformation, the wire electrode deforms plastically. This deformation is irreversible. If the tensile force is returned to zero, the wire electrode thus remains deformed. This is of course also the case if the wire electrode breaks. The plastic region is therefore the range of tensile forces between the above-mentioned threshold value and the tensile force at which the wire electrode breaks. If the wire electrode has an extension in its plastic state of up to 10%, the total diameter of the free end of the wire electrode after breaking is small enough that the wire electrode can easily be threaded in. In many commercially available erosion machines, the ability to be automatically threaded in is an important requirement for the wire electrodes which can be used. The inventive wire electrode developed thus can therefore be used without problems in common unwinding, automatic threading, guiding and cutting devices. There are a great many possibilities for bringing about the ten percent extensibility of the wire electrode in its plastic region. It can for example be brought about by expedient heating of the wire electrode, or by means of a suitable metallurgic composition of the steel core and of the coating.

As already explained above, the electrical conductivity of the steel is often not sufficient for the demands. According to the invention, the cheap steel of the steel core is not excessively loaded with current since the principal current path extends in the coating of the wire electrode, which is a much better electrical conductor. Common frequencies for erosion discharges are in the region of 50 kHz. This leads, by virtue of what is referred to as the skin effect, to an increase in the current density at the outer edge of the wire electrode, which further supports the takeover of the current by the coating. The current flowing in the core is shifted, in the vicinity of the boundary surface, to the coating and thus into the iron-zinc alloy layer. The steel of the steel core is thus advantageously designed so as to promote this effect and such that the current flows almost entirely within the coating. The steel core is therefore preferably created from a steel having a magnetic permeability μᵣ between 5000 and 10,000. Such a steel of the steel core, which is preferred in the context of the invention, contains at most 6 wt % silicon.

Such steels are also used in the manufacture of transformer laminations. Advantageously, the steel core has an electrical resistivity of less than 15 μΩcm.

Advantageously, the coating has an outer layer of pure zinc which surrounds the iron-zinc alloy layer. Zinc has interesting properties for fine machining and produces improved electrical touch. Furthermore, the presence of zinc is very important for metrological reasons.

Other metals such as magnesium or aluminium can also provide interesting properties for spark erosion. The presence of these materials in the iron-zinc alloy layer can for example accelerate the machining of a workpiece. Advantageously, therefore, the iron-zinc alloy layer contains aluminium and/or magnesium, wherein the aluminium fraction is less than 8 wt % and the magnesium fraction is less than 5 wt %. The iron-zinc alloy layer formed in this manner expediently contains, in the vicinity of the steel core, a component of diffused iron. The iron is diffused from the steel core into the coating, for example during the diffusion by means of heat treatment. These types of alloy make it possible to further reduce production costs.

In the case of a method for producing a wire electrode for spark erosion, having a total diameter between 0.05 and 0.4 mm, a continuous iron-zinc alloy layer, consisting of iron and zinc, is for example deposited onto a steel core consisting of steel, whose diameter corresponds to the total diameter of the wire electrode minus the desired thickness d of the alloy layer.

Advantageously, the wire electrode is drawn to its final diameter after deposition of the iron-zinc alloy layer, wherein the total diameter is reduced as little as possible, for example by at most 0.01 mm, in order to avoid tearing the alloy layer.

The above-mentioned advantages can be obtained only if the diameter of the steel core used at the beginning of the production process is close to the final diameter of the finished wire electrode. The tolerances to be observed in this context are for example in the range from +0.002 mm to −0.004 mm. The drawing process, which for example follows the deposition of the iron-zinc alloy layer onto the steel core, is intended to ensure calibration and may not reduce the total diameter to below a predefined threshold value, since that would break up the iron-zinc alloy layer and expose the steel core. This would not only have a negative effect on the conductivity of the wire electrode, but would also lead to undesirable oxidation of the iron in the exposed steel core. Advantageously, therefore, the total diameter of the wire electrode is expediently reduced during drawing of the coated steel core. This maintains the continuity of the current-conducting layer, such that the electrical resistance of the wire electrode is not increased.

For example, in the production method, a zinc layer is first deposited onto the steel core. The wire thus coated can then be annealed, wherein iron particles diffuse into the zinc layer, so as to form the desired iron-zinc alloy layer. It is then still possible for the wire electrode to be drawn to the final diameter—that is to say the total diameter of the finished wire electrode—while observing the above-mentioned safety measures.

The structure of the deposited zinc layer and thus the structure of the subsequent iron-zinc alloy layer is dependent on the chosen deposition step. If the zinc is deposited onto the steel core by electrolytic means, there results deposition in solid form. Thermal diffusion is then absolutely necessary in order to drive the iron from the core into the coating and to thus produce the iron-zinc alloy. In that process, the wire is heated, resulting in an alloy consisting of multiple concentric phases. The zinc-rich phases are more ductile than the zinc-poor phases of the iron-zinc alloy layer. They are located at the outer edge of the iron-zinc alloy layer, oriented away from the steel core. The other, more brittle, iron-zinc alloy phase is by contrast formed on the inner edge, adjoining the steel core. This structure, which is very advantageous for a spark erosion wire, therefore makes it possible to enclose the more brittle phase with a ductile phase such that the wire electrode can be drawn within tight limits without the iron-zinc alloy layer breaking up. Furthermore, an advantageous zinc-rich layer is generated in the periphery. In addition, an also advantageous polyvalent wire electrode is provided.

In the case of the method referred to as dipping, which is also possible as deposition step within the context of the invention, the outer layer is deposited in liquid form. The respective coating layer is applied by dipping the steel wire into liquid zinc or into a liquid iron-zinc mixture. Phase formation is more complex in this case and is dependent on the type and temperature of the bath. A single dipping step can thus take the place of electrolytic deposition and the subsequent thermal diffusion.

A galvanizing bath (dipping) also makes it possible to directly form a precise metallurgical phase and/or to introduce other metals such as aluminium, magnesium or nickel into the iron-zinc alloy layer. Aluminium and magnesium cannot be deposited electrolytically.

Further expedient embodiments and advantages of the invention form the subject matter of the following description of exemplary embodiments of the invention with reference to the figures of the drawing, wherein identical reference signs indicate components having the same effect, and wherein

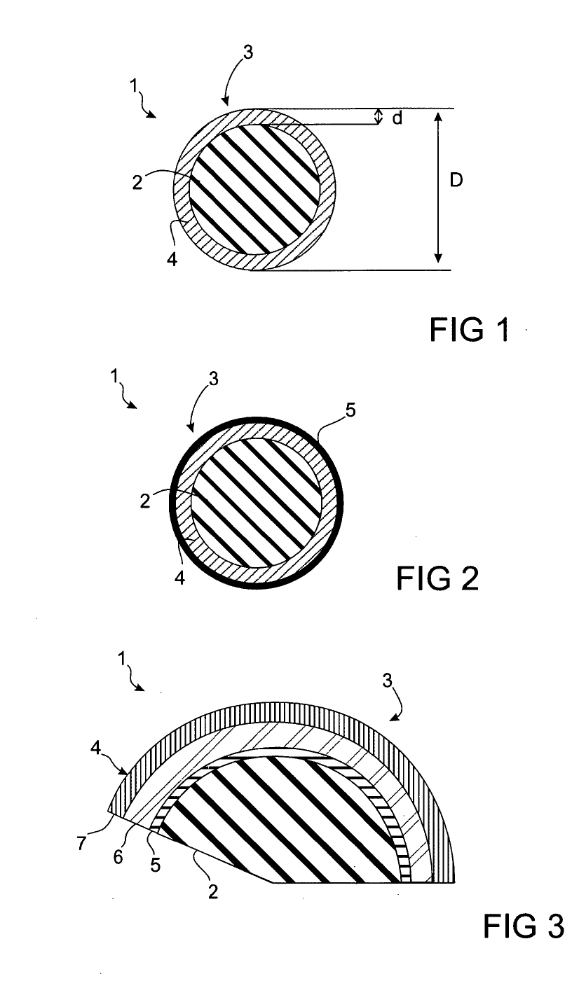

FIGS. 1-3 show, more clearly, various exemplary embodiments of the inventive wire electrode in a schematic cross-sectional view,

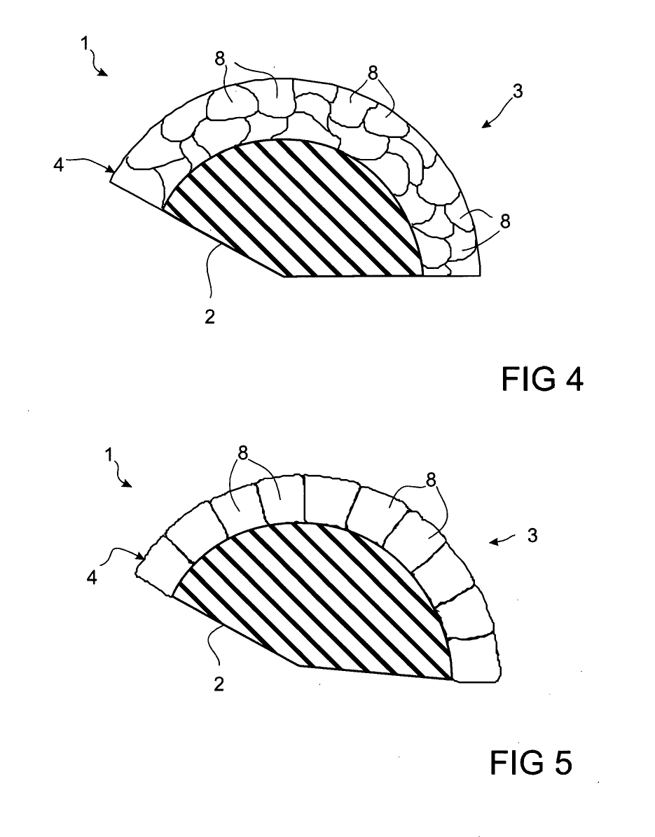

FIG. 4 shows a highly magnified schematic view of an iron-zinc alloy layer with tight layer elements in the form of plates,

FIG. 5 shows a highly magnified schematic view of an iron-zinc alloy layer with tight layer elements in the form of mutually adjacent clusters, and

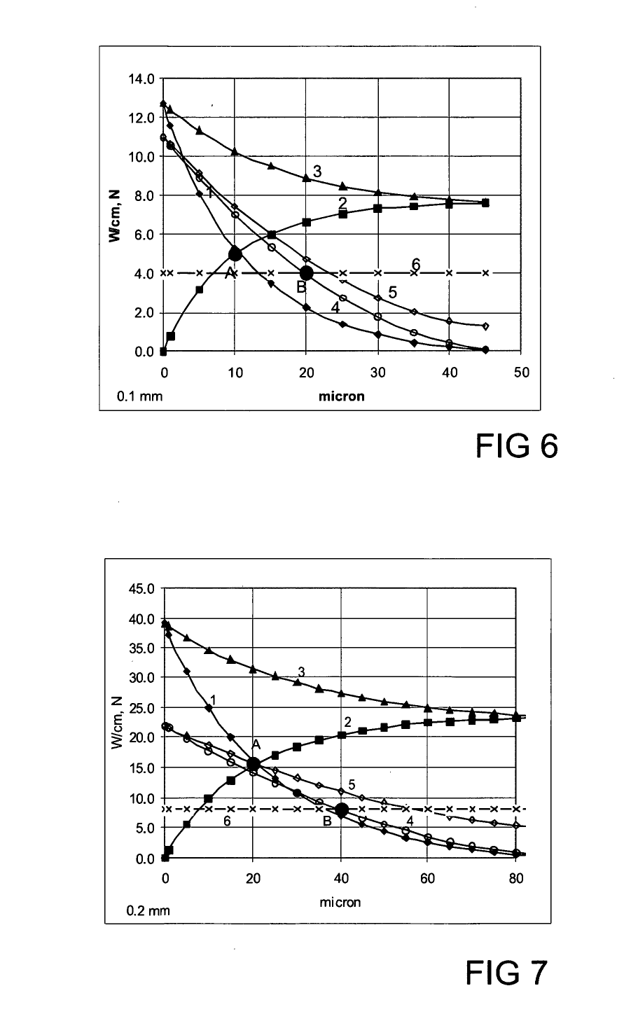

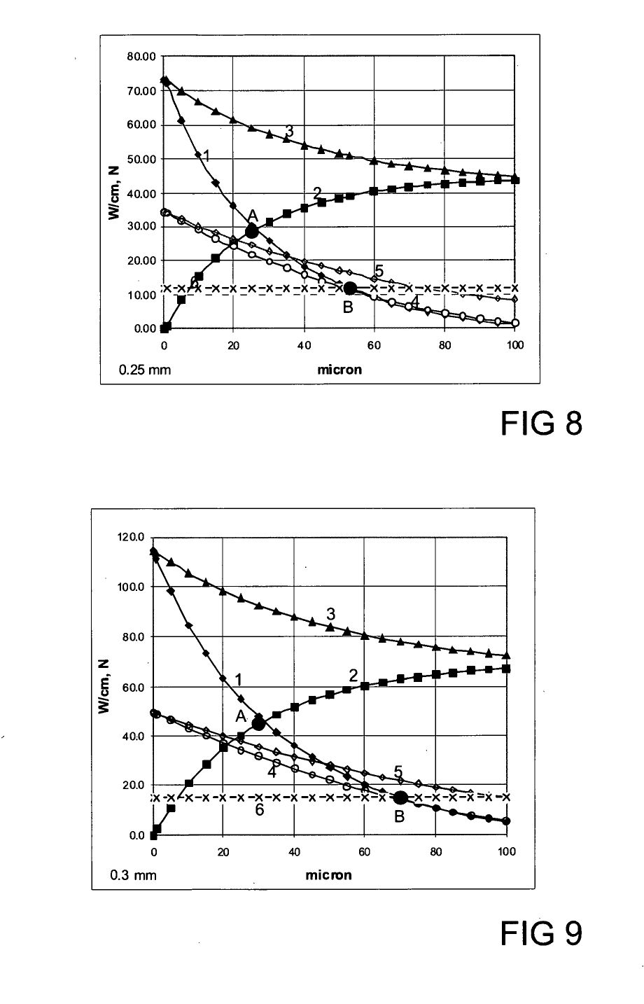

FIGS. 6-9 show the breaking stress and the electrical power loss of wire electrodes having a total diameter of 0.1 mm, 0.2 mm, 0.25 mm and, respectively, 0.3 mm, as a function of the thickness of the respective iron-zinc alloy layer.

FIG. 1 shows an exemplary embodiment of the wire electrode 1 according to the invention, in a schematic cross-sectional view. The wire electrode 1 is essentially circular in cross section, extending in the longitudinal direction with an approximately constant total diameter D. The total diameter D of the wire electrode is shown clearly in FIG. 1. The wire electrode 1 has a central steel core 2 consisting of an appropriate steel. The steel core 2 is enclosed by a coating 3 which in the exemplary embodiment shown consists exclusively of an iron-zinc alloy layer 4.

The wire electrode 1 shown in FIG. 1 has a total diameter D of 0.1 mm. The thickness d of the iron-zinc alloy layer 4 is 12 μm. The iron fraction of the iron-zinc alloy layer 4 starts between 25 wt % and 29 wt %. The carbon fraction of the steel core 2 is 0.5 wt %.

FIG. 2 shows a further exemplary embodiment of the wire electrode 1 according to the invention, wherein however the coating 3 comprises, in addition to an iron-zinc alloy layer 4, a zinc layer 5 which externally encloses the iron-zinc alloy layer 4. This provides an external zinc-rich layer which is advantageous for final machining. Also achieved is a polyvalent wire. only part of the wire electrode 1 is visible. The wire electrode 1 once again has a steel core 2 which is surrounded by a coating 3 consisting of an iron-zinc alloy layer 4. It can be seen that the iron-zinc alloy layer 4 has multiple concentric annular phase layers 5, 6 and 7, wherein phase layer 5 is a γ-phase, phase layer 6 is a δ-phase and phase layer 7 is ξ-phase. The zinc fraction of the iron-zinc alloy layer 4 thus increases progressively from phase layer 5 to phase layer 7. Phase layers 6 and 7 are therefore more ductile than the inner, more brittle phase layer 5. This arrangement substantially reduces the risk of the iron-zinc alloy layer 4 breaking up.

FIGS. 4 and 5 each shows a further exemplary embodiment of the wire electrode 1 according to the invention, which is again shown in a partial cross-sectional view. Particularly visible is the construction of the iron-zinc alloy layer 4 which, both in the case of the wire electrode 1 of FIG. 4 and in the case of the wire electrode 1 of FIG. 5 consists of a tight packing of layer elements 8 which form mutually different alloy phases. The layer elements 8 are in contact with one another so as to form a continuously conductive current path in the iron-zinc alloy layer 4. The zinc fraction of the layer elements 8 can vary from layer element 8 to layer element 8 and, in the exemplary embodiment shown in FIG. 4, is between 65 and 75 wt %, increasing outwards, that is to say towards that side of the coating 3 oriented away from the steel core 2. For metallurgic reasons, the zinc fraction does not increase progressively (in other words linearly) in the outward direction. Moreover, the zinc fraction also varies here in stepwise fashion and, in any one phase, is higher the further that phase is arranged from the core.

In the case of the wire electrode 1 shown in FIG. 4, the layer elements 8 are configured as plates arranged entwined with one another. FIG. 5, by contrast, shows layer elements 8 which are configured as mutually adjacent clusters or blocks. In each of the exemplary embodiments shown in FIGS. 4 and 5, the layer elements 8 are packed tightly such that the iron-zinc alloy layer 4 forms a gas-tight barrier around the steel core 2, whose iron constituents are thus protected from aggressive atmospheric oxygen.

The total diameter D of wire electrodes 1 which are used in practice for spark erosion varies between 0.05 mm and 0.4 mm. In the production of the inventive wire electrode, which can be dimensioned accordingly, it is necessary, for the respective application, to find the most expedient compromise between five properties which are in some cases contrary to one another in the sense that improving one property leads to a deterioration in another property. These properties are:

the conductivity of the overall wire electrode,

its breaking strength, in order to withstand the mechanical loads,

the strength of the iron-zinc alloy layer with respect to wear during spark erosion,

the ability of the iron-zinc alloy layer to protect the steel core from rusting,

the expedient magnetic permeability of the steel core.

Steel is a much more cost-effective material than copper or brass. This is a decisive advantage over wire electrodes consisting of brass and having comparable properties.

The inventive method used for the production of the inventive wire electrode depends on the ductility of the steel core and of the coating deposited thereon. If however the ductility of the coated steel core is not sufficient, one should either dispense with a subsequent drawing process or limit this to a small extent. A certain plastic deformation of the inventive wire electrode is indispensable in the field of spark erosion bearing in mind the requirements of that application, for example in the case of automatic threading. Therefore, some machines in which the inventive wire electrode is to be used are equipped with an annealing device which simplifies threading of the wire electrode. In the case of low-carbon steel, sufficient plastic deformation of the wire electrode is achieved by means of an increase in temperature.

Plasticity is useful for threading: during preparation of the wire electrode, it allows necking of the wire such that the latter is sharpened and can be threaded through the guides of the upper and lower heads of the spark erosion machine.

Increasing the concentration of carbon in the steel of the steel core increases the elastic modulus of the latter, which can thus be made to vary between 8000 kg/mm² and 16,000 kg/mm². In the case of a wire with a total diameter of 0.25 mm, the minimum bending radius, for example 50 mm, can be doubled by increasing the concentration of carbon. Prior art wire electrodes having a steel core, a total diameter greater than 0.25 mm and a breaking strength of greater than 2000 N/mm² are therefore unsuitable for spark erosion machines. These stiff wires can be fed into the machines currently used only with considerable difficulty and can even damage them. The majority of machines used in practice are furthermore generally equipped with a cutter which is arranged behind the machining zone. The maximum shear force of this cutter is limited. Wire electrodes having a total diameter of greater than and a concentration of carbon greater than 0.2 wt % are cut only insufficiently or not at all, such that damage to the cutting device cannot be excluded. The previously known wire electrodes having a diameter of 0.25 mm and a breaking strength of greater than 1300 N/mm² are generally unsuitable for the cutting and transport devices of the majority of spark erosion machines,

In order to achieve sufficient breaking strength for a given wire diameter, it is possible to reduce the thickness of the coating, insofar as the latter has a mechanical strength lower than that of the core. As has already been explained, the core is primarily responsible for the mechanical strength of the wire electrode. Its diameter must therefore be large enough to ensure sufficient mechanical strength. By contrast, since the steel core is a poor conductor, the coating must have a minimum thickness in order to provide the overall conductivity even during the machining of workpieces and the associated wear of the coating.

When selecting the steel for the steel core, it is also necessary to take into account the magnetic properties of the respective steel. The current flowing through the steel core can generate a magnetic field which is disadvantageous for the cutting process and which leads to curvature of the wire electrode in the machining zone, leading to a deterioration in cutting precision. In order to avoid these drawbacks, the steel of the inventive wire electrode has retentivity which is as low as possible. Low-retentivity steels are primarily low-carbon steels which however at the same time have the required mechanical strength. This can be achieved by setting the silicon content in the steel core. Within the context of the invention, it has been recognized that steels used for the production of transformer laminates are also remarkably well-suited to the production of the steel core.

FIGS. 6 to 9 make it possible, within the context of the invention, to simply establish the mechanical strength of the steel core and the overall electrical conductivity of the wire electrode for a given total diameter. The figures represent wire electrodes having a total diameter of 0.1 mm, 0.2 mm, 0.25 mm and 0.3 mm, respectively.

The respective abscissa shows the thickness of the iron-zinc alloy layer in microns. The ordinate represents both the electrical power loss in Watt/cm and the breaking stress of the wire in N, the same number scale being valid for both variables.

The various electrical powers were achieved with an RMS current of 10 A for a wire diameter of 0.1 mm, 35 A for a wire diameter of 0.2 mm, 60 A for a wire diameter of 0.25 mm and 90 A for a wire diameter of 0.3 mm. This RMS current was generated with a sequence of electric sawtooth pulses, wherein the slope of the characteristic was greater than 300 Alps. The electrical specific resistivity of the coating layer was 6 μΩ*cm and that of the core was 10 μΩ*cm.

The curve labeled 1 in each of FIGS. 6 to 9 represents the electrical power loss in the steel core. The respective curve 2 represents the electrical power loss in the coating layer, the curve 3 represents the overall electrical power loss and the curve 4 represents the breaking stress of the steel core. The respective curve 5 represents the breaking stress of the covered wire electrode when the iron-zinc alloy layer is worn away by 50% (this corresponds to the usual wear of the wire during spark erosion). The horizontal line 6 represents the maximum mechanical breaking stress to which the wire electrode having the indicated total diameter is subjected in the usual machines.

As expected, in all of the diagrams the electrical power loss in the iron-zinc alloy layer increases with increasing thickness of the iron-zinc alloy layer, with the overall mechanical strength of the wire electrode being reduced.

If the iron-zinc alloy layer is set to a thickness which corresponds to a value to the right of the respective point A (intersection of curves 2 and 1), the electrical power loss in the iron-zinc alloy layer is increased and approaches that of the steel core. However, increasing the layer thickness reduces the mechanical strength. It is advisable not to lower the mechanical strength beyond a threshold value below which the wire electrode can break during the spark erosion process. This threshold value is reached at point B, at which the maximum breaking stress (curve 5) drops below the maximum tensile stress (curve 6) of the erosion machine. The optimum layer thickness is therefore a value to the right of point A and to the left of point B.

Analysis of the curves shows that the iron-zinc alloy layer 4 must be between 5% and 25% of the total wire diameter. This makes it possible to produce a broad range of wires depending on the selected coating thickness, wherein certain wire electrodes (with a thin coating layer) are better suited to finish machining and others (with a thicker coating layer) perform better for a high machining rate or in the case of bad flushing conditions.

The tests carried out have led to the conclusion that a simple iron wire without a coating permits only a very low machining rate since, during cutting, there form redeposits which originate in the cut workpiece and lead to high risk of breakage. This behavior corresponds to that of a pure copper layer. Neither would a coating consisting of pure zinc raise the cutting rate to an adequate level. The reason for this lies in the high wear rate of pure zinc in view of its low melting point. Even a very thick, for example 25 micron thick, coating layer of pure zinc does not increase the rate of the cutting process. Only an iron-zinc alloy layer makes it possible to increase the cutting rate of a wire electrode to the point that it corresponds to that of a wire electrode having a copper-zinc coating. It can therefore be assumed that an iron-zinc alloy layer wears less than an uncoated steel wire or a steel wire having a pure zinc layer. Too thin an iron-zinc alloy layer, by contrast, cannot provide a sufficient effect. Such a wire electrode has properties close to those of a pure steel wire. If, however, the thickness of the iron-zinc alloy layer is markedly increased, and increased above the level known heretofore, it has surprisingly been observed that the redeposits can be greatly reduced. The iron-zinc alloy layer is thus entirely different from the zinc-copper alloy layer. It makes it possible to increase material removal and to reduce the number of finishing passes, since after the pass of the wire there are no redeposits.

In summary, it can be established that the thickness of the iron-zinc alloy layer must be substantially greater than was the case for wire electrodes known heretofore.

1.-16. (canceled)

17. A wire electrode for spark erosion comprising, a total diameter between 0.05 and 0.4 mm, an inner steel core made of steel and an outer coating surrounding said steel core, wherein the outer coating includes an iron-zinc alloy layer of a thickness which at a thinnest point is greater than 5% of the total diameter and at its thickest point is less than 25% of the total diameter.

18. The wire electrode as claimed in claim 17, wherein the iron-zinc alloy layer forms a continuously conductive current path in the coating.

19. The wire electrode as claimed in claim 18, wherein the iron-zinc alloy layer takes a form of tightly packed layer elements, wherein the layer elements are in contact with one another.

20. The wire electrode as claimed in claim 17, wherein the iron fraction of the iron-zinc alloy layer is less than or equal to 50 wt %.

21. The wire electrode as claimed in claim 17, wherein the zinc fraction of the iron-zinc alloy layer is greater than or equal to 60 wt %.

22. The wire electrode as claimed in claim 17, wherein the zinc fraction in the iron-zinc alloy layer increases towards its outer surface.

23. The wire electrode as claimed in claim 17, wherein the total diameter is less than or equal to 0.2 mm and the steel of the steel core contains between 0.2 and 0.6 wt % carbon.

24. The wire electrode as claimed in claim 23, wherein the steel core has a breaking strength between 1000 and 3000 N/mm².

25. The wire electrode as claimed in claim 17, wherein the total diameter is greater than 0.20 mm and the steel of the steel core contains not more than 0. 2wt % carbon.

26. The wire electrode as claimed in claim 25, wherein the steel core has a breaking strength between 300 and 1100 N/mm².

27. The wire electrode as claimed in claim 26, wherein the steel core is constructed plastically deformable in a plastic region when subjected to a tensile force, and has an extension in its plastic region of at least 10%.

28. The wire electrode as claimed in claim 17, wherein the steel core has a relative magnetic permeability μᵣ between 5000 and 10,000.

29. The wire electrode as claimed in claim 28, wherein the steel core contains silicon in a fraction of not more than 6 wt %.

30. The wire electrode as claimed in claim 17, wherein the steel core has an electrical specific resistivity of less than 15 μΩcm.

31. The wire electrode as claimed in claim 17, wherein the coating has an outer zinc layer made of pure zinc, which externally encloses the iron-zinc alloy.

32. The wire electrode as claimed in claim 17, wherein the iron-zinc alloy layer contains aluminium and/or magnesium, wherein the aluminium fraction is less than 8 wt % and the magnesium fraction is less than 5 wt %.

33. A wire electrode for spark erosion comprising, a total diameter between 0.05 and 0.4 mm, an inner steel core made of steel and an outer coating surrounding said steel core, wherein the outer coating includes an iron-zinc alloy layer of a thickness which at a thinnest point is greater than 5% of the total diameter and at its thickest point is less than 25% of the total diameter, wherein the total diameter is less than or equal to 0.2 mm and the steel of the steel core contains between 0.2 and 0.6 wt % carbon wherein the steel core has a breaking strength between 1000 and 3000 N/mm², or the total diameter is greater than 0.20 mm and the steel of the steel core contains not more than 0.2 wt % carbon, wherein the steel core has a breaking strength between 300 and 1100 N/mm².
